(19) United States
(12) Patent Application Publication
(10) Pub. No.: US 2009/0091166 A1
(43) Pub. Date: Apr. 9, 2009

(54) SEATING SYSTEM USING CLOSED CELL MATERIALS

(75) Inventor: Hemant Jha, Chicago, IL (US)

Correspondence Address: FITCH EVEN TABIN AND FLANNERY, 120 SOUTH LASALLE STREET, SUITE 1600, CHICAGO, IL, 60603-3406, US

(73) Assignee: THINK/THING, Chicago, IL (US)

(21) Appl. No.: 12/244,585

(22) Filed: Oct. 2, 2008

Related U.S. Application Data
(60) Provisional application No. 60/977,571, filed on Oct. 4, 2007.

(51) Int. Cl. A47C 7/18; A47C 1/11; A47D 1/00; B60N 2/26

(52) U.S. Cl. 297/250.1; 297/452.48

(57) ABSTRACT

A seat includes a base portion and a seat portion arranged to communicate with the base. The seat portion is formed at least in part from a varying density closed cell foam polymer resin material.

### CROSS REFERENCE TO RELATED APPLICATIONS

This application claims priority to provisional application 60/977,571, entitled “Child Seating System Constructed from Closed Cell Materials”, filed Oct. 4, 2007, which is incorporated herein by reference in its entirety.

### FIELD OF THE INVENTION

This application relates to seats in general and, more specifically, to their composition.

### BACKGROUND

There are various types of car seats that have been developed over the years to secure children in automobiles or other vehicles. These seats may be categorized into various groups based on the weight, age and size of the child that they are designed to hold and secure.

Rear-facing seats are one type of seating arrangement that are sometimes used. More specifically, it is recommended that all infants should ride in a rear-facing position until they have reached at least one year of age and weigh at least 20 pounds.

There are two types of rear-facing seats: infant-only seats and convertible seats. Infant-only seats are small and have carrying handles and some have a built-in harness. In one example, infant-only seats are used for infants from birth up to 22 to 30 pounds. Many of these types of seats come with a base that can be left in the car.

Convertible seats can be used rear-facing for infants, and then turned forward-facing once the child is old enough and big enough to do so safely. These are typically used rear-facing from birth until the child is at least one year of age and at least 20 pounds. Convertible seats typically have higher rear-facing weight limits than infant-only seats and can advantageously be used to secure larger babies or children.

Convertible seats can utilize various types of harnessing arrangements. For example, they can use a five-point harness. The five-point harness includes five points of attachment: two at the shoulders, two at the hips, and one at the crotch. Another type of harness that can be used is the overhead shield with a padded tray-like shield that swings down over the child. Still another type of harness is the T-shield. The T-Shield harness utilizes a padded t-shaped or triangle-shaped shield attached to the shoulder straps.

Once the child is at least one year of age and weighs at least 20 pounds, they often can ride in a forward-facing seat. There are various types of seats that can be used in a forward-facing configuration: convertible seats, built-in seats, combination forward-facing/booster seats, and travel vests to name a few. These seats typically have a five-point harness. Built-in forward-facing seats are available in some cars and vans by the manufacturer of the vehicle.

As mentioned, combination forward-facing/booster seats have also been developed. Some car safety seats can be used as both a forward-facing seat and a booster. In one example, these seats come with harness straps for children who weigh up to 40 to 65 pounds. Once the child reaches the weight or height limit for the harness, one can use the seat as a booster by removing the harness and using the vehicle's lap and shoulder seat belts.

Travel vests can be used for a child who has outgrown their seat with a harness but is not yet ready for a booster seat or cannot use a booster seat because the vehicle only has lap seat belts in the rear.

Booster seats are designed to raise the child so that the lap and shoulder seat belts fit properly. In this case, the lap belt lies low across the child's upper thighs and the shoulder belt crosses the middle of the child's chest and shoulder. Correct belt fit helps protect the stomach, spine, and head from injury in a crash. Both high-back and backless booster seats are available. Booster seats often do not come with harness straps but are used with the lap and shoulder seat belts in the vehicle, the same way an adult rides. Booster seats are typically used until the child can correctly fit in lap and shoulder seat belts.

Typically, the structural supports or the base for the seat are made of rigid plastics or a combination of plastics and metal components. The harness is typically made of a strong, non-elastic material fashioned into straps. The other components of the harness may be constructed of plastic and metal. The seating surface, which is any surface that the child may come in contact with while seated in the child seat, is made of fabric or fabric-type covering. The covering is typically removable and typically has either a full layer of foam underneath or smaller foam pads.

As mentioned, the seating surface, which may be any surface that the child may come in contact with while seated in the child seat, is typically made of fabric or fabric type covering. Unfortunately, a fabric based seating surface has various drawbacks.

For example, moisture absorption may be a problem. More specifically, fabric is typically not moisture repellant in its natural state. In the event of a liquid spill in the seat, the liquid is absorbed into the fabric, which creates a wet and unpleasant environment for the child to be seated. Various kinds of moisture repellant finishes may be applied to the fabric to make it more repellant. However, these finishes wear out over time and through frequent use. In the event a moisture repellent finish is not used, the liquid will saturate the material, necessitating the removal of the cover from the seat and subsequent washing of the cover. This can often be a time-consuming and laborious process. In such a situation, it is possible that the caregiver to the child may leave the cover dirty or only superficially cleaned, which may create an unhealthy, unhygienic and potentially damaging environment for the child.

Lack of thermal insulation is also a drawback of previous approaches. Typically, a single layer of fabric of the type used in car seats does not afford an appreciable level of thermal insulation, especially in colder weather. Insulation may be provided by multiple layers of fabric or a single layer of fabric in conjunction with other insulating materials.

Surface finish can also be a problem for previous approaches. For instance, most fabric surfaces suitable for car seats have a fine weave and smooth finish, with a non-tacky surface. These surfaces may be suitable for ease of maintenance and cleanup in the event of a spill. However, in the event of a sudden movement such as a collision, smooth and fine finishes do not provide a gripable surface for the body of the seat occupant to hold onto or be held onto. A gripable surface may be applied to the surface of the fabric, or a special textured surface may be woven into the fabric. However, both of these approaches make cleanup in the event of a spill or general maintenance more difficult.

The large number of components used in previous systems also causes problems. More specifically, the fabric cover does not have cushioning or insulating properties of its own and must work in conjunction with foam padding placed or attached underneath. This leads to complexity in manufacture and assembly, which may translate into higher costs. Increase in the number of components also increases the possibility of failure and unsatisfactory performance, damage to the child seat and the occupant.

### BRIEF DESCRIPTION OF DRAWINGS

FIG. 1 is a perspective view of an infant-only seat according to various embodiments of the present invention;

FIG. 2 is a is a perspective view of a convertible child seat according to various embodiments of the present invention;

FIG. 3 is a is a perspective view of another example of a convertible seat according to various embodiments of the present invention;

FIG. 4 is a perspective view of a booster seat according to various embodiments of the present invention;

FIG. 5 is a partial sectional view of a seating surface according to various embodiments of the present invention;

FIG. 6 is a view of a seating surface according to various embodiments of the present invention;

FIG. 7 is a partial sectional view of a seating surface according to various embodiments of the present invention; and

FIG. 8 is a partial sectional view of a seating surface according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

In the approaches described herein, certain types of seating (e.g., child seating) and other types of seating arrangements are described. However, it will be appreciated that the approaches described herein are applicable to any type of seating system or arrangement as well as other types of seating arrangements. Additionally, it will be appreciated that these approaches may be used for seating arrangements for either children or adults.

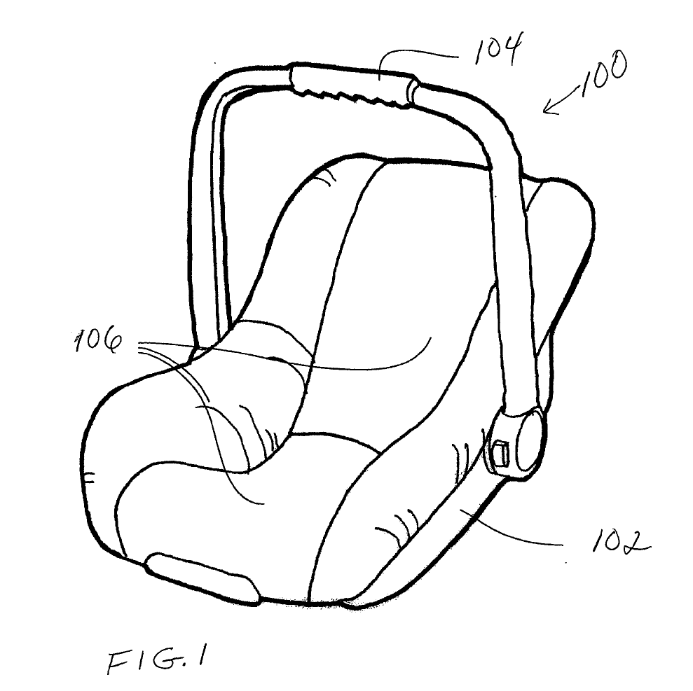

Referring now to FIG. 1, a seating system 100 includes a frame 102, handle 104, and seating surfaces 106. In this example, the seating system 100 is an infant-only seat. The seating surfaces 106 include all surfaces that a child or individual comes into contact with while seated including, for example, the bottom of the seat, back of the seat, and the arm rests.

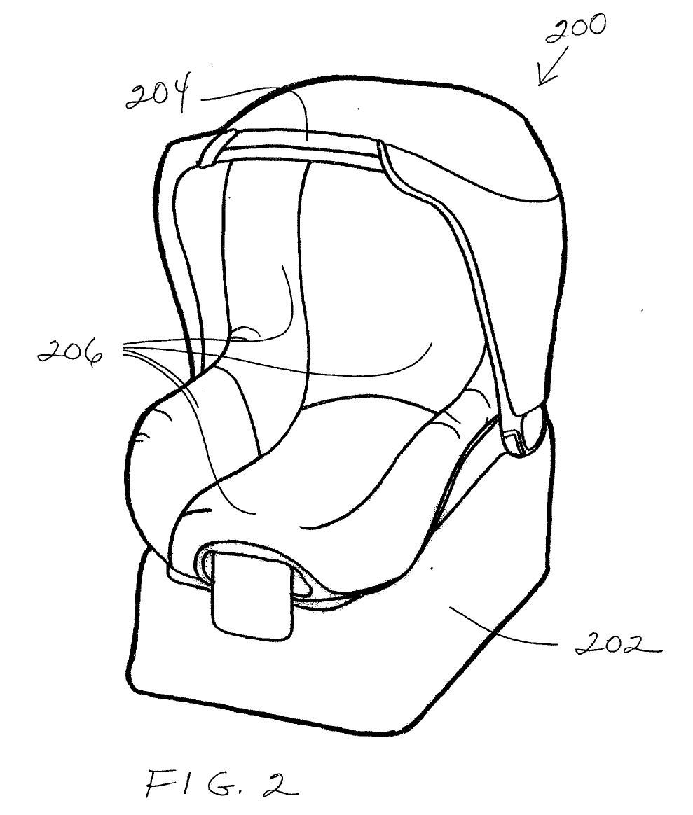

Referring now to FIG. 2, a seating system 200 includes a frame 202, handle 204, and seating surfaces 204. In this example, the seating system 200 is a convertible seat. As with the other examples described herein, the seating surfaces 204 include all surfaces that a child or individual comes into contact with while seated including, for example, the bottom of the seat, back of the seat, and the arm rests.

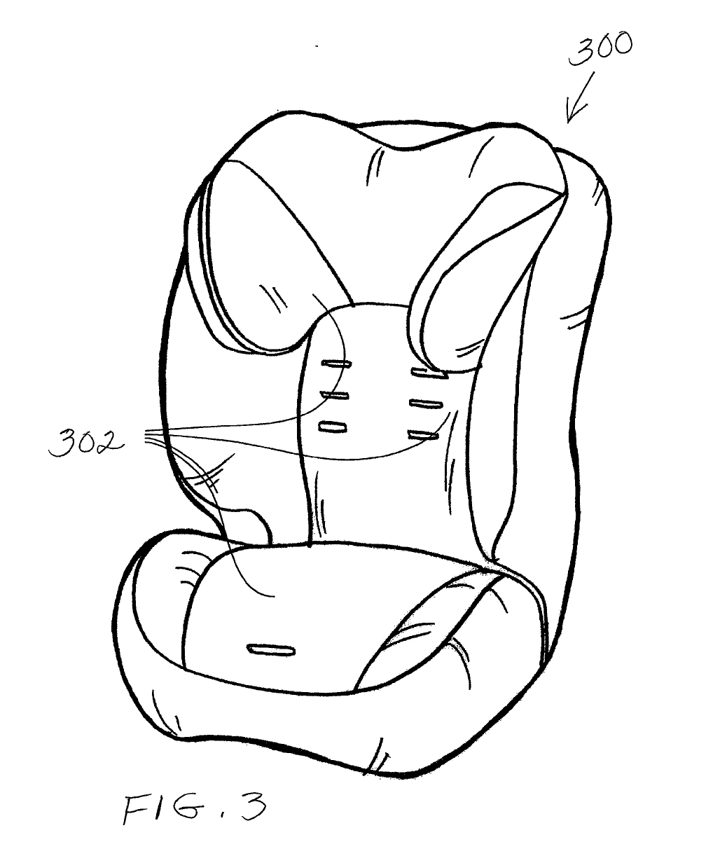

Referring now to FIG. 3, a seating system 300 includes seating surfaces 302. In this example, the seating system 300 is a convertible seat. As with the other examples described herein, the seating surfaces 302 include all surfaces that a child or individual comes into contact with while seated including, for example, the bottom of the seat, back of the seat, and the arm rests.

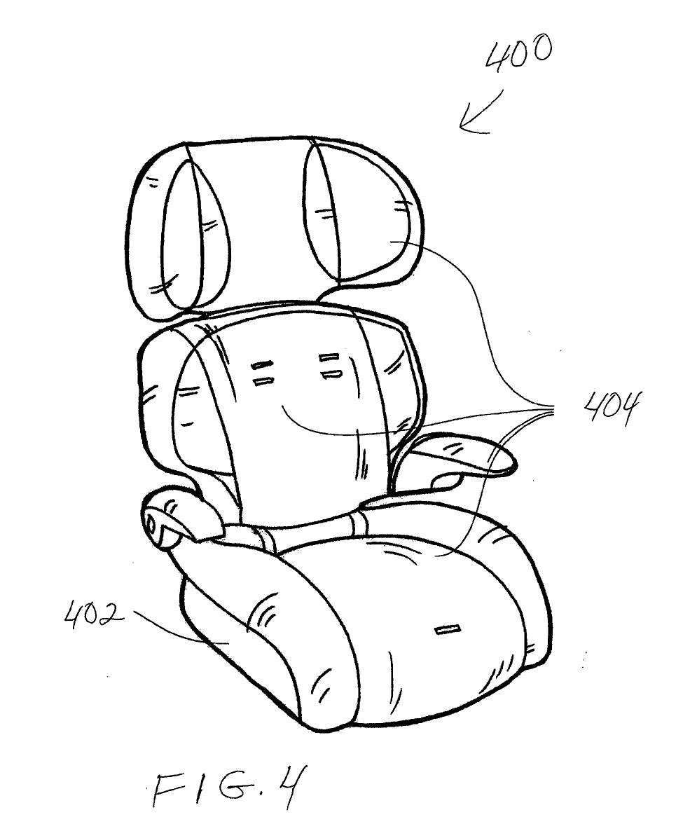

Referring now to FIG. 4, a seating system 400 includes a frame 402 and seating surfaces 404. As with the other examples described herein, the seating surfaces 404 include all surfaces that a child or individual comes into contact with while seated including, for example, the bottom of the seat, back of the seat, and the arm rests.

It will be appreciated that the above-mentioned seating systems have other components, for example, structural components or bases (not shown). As mentioned, it will also be understood that other examples of other types of seating systems may also utilize the approaches described herein.

In all above described examples, the structural supports or the base for the seat are made of rigid plastics or a combination of plastics and metal components. Additionally, the structural component of the seat is fastened to the automotive seat using the seat belts of the automobile or the federally mandated LATCH system. The harness may be made of a strong, non-elastic material fashioned into straps. The other components of the harness such as latches and fasteners are made of any type of appropriate plastic and metal.

The seating surfaces (e.g., seating surfaces 106, 204, 302, 402, 502, 602, 704, and 804 as described herein), which include any surface that the child occupant (or other occupant) of the seat may come in contact with while seated in the seat are made of varying density closed cell foam polymer resin material. The closed cell foam components may be permanently or removably attached to the underlying structure.

In some examples, all seating surfaces are constructed of the material. In other examples, only selected surfaces are constructed of the material. For instance, to take one example, only the seat, seat back and armrest areas are made of this material. In other approaches, all surfaces and the entire seat are constructed of the material. In yet other approaches, the material may be bonded to a fabric that covers the seat. In still other examples, the material may be formed around a core (of another material). In yet other approaches, pads can be constructed of the material and placed on the seat.

In some examples, the seat portion may be formed of a non-foam polymer resin material mixed with a filler material such as cork or sawdust, among others. The seat portion may also be formed of a non-foam polymer material fully or partially enclosing a core of another material. For example, the core may be constructed of air, soft gel, styrofoam, among others

In one example, the varying density closed cell foam polymer resin material is Ethylene Vinyl Acetate or EVA. EVA is a polymer that approaches elastomeric materials in softness and flexibility, yet can be processed like other thermoplastics. The material has good clarity and gloss, barrier properties, low-temperature toughness, stress-crack resistance and resistance to UV radiation.

In one particular approach, a closed cell polymer resin material such as CROSLITE® may be used. CROSLITE® is a closed cell polymer resin material which is made using ethylene vinyl acetate, EVA. CROSLITE® is owned by Crocs, Inc., 6328 Monarch Park Place, Niwot, Colo. 80503, USA. In another embodiment, LEVIREX may be used, which is a type of EVA marketed by FINPROJECT of Italy. In addition, any other suitable polymer or copolymer resin may be used.

In the examples described herein, the foams do not have interconnected pores and these are referred to as closed cell foams (as opposed to open cell foams where the pores are interconnected). Typically, the closed cell foams have higher compressive strength than open cell foams due to their structures. Additionally, the closed cell structure foams have higher dimensional stability, low moisture absorption coefficient and higher strength compared to open cell structured foams.

In some approaches, the varying density closed cell foam polymer resin material is mixed with additives such as natural cork, rubber, sawdust or non reactive filler material. One advantage of mixing the material with these additives is a reduction in weight of the seat or reduction in the amount of synthetic materials used, among other advantages. In one example, 60 percent cork by volume may be added to 40 percent polymer resin.

In some approaches, the seat components are formed by pouring a liquid version of the resin into a mold and allowing it to set, at which point it is removed from the mold. Depending on the final desired result and the exact composition of the resin material used, additives may be added during, before or after this process to cause the qualities of color, stiffness, crosslinking and pore size to change. In an alternate process, a mixture or combination of resin, pigment and growth additive is simultaneously poured into a mold.

In another example, a dense and relatively non-porous top surface may be formed with a very porous and softer consistency underneath. This may be accomplished or facilitated by using various chemical or physical approaches. One chemical approach includes spraying the inside of the mold with a densifying agent before the liquid resin is pored into the mold. The agent chemically bonds to the liquid resin on contact, creating a denser surface layer. One physical approach includes vibrating the mold after the resin has been poured into the mold, causing newly formed foam bubbles to rise away from the surface closest to the walls of the mold, leaving the formed resin structure denser in those areas. Other examples of chemical and physical approaches are possible.

In another approach, a fabric or fabric like material may be incorporated into the seating surface at the time of manufacture of that surface. For example, a fabric material may be laid into the mold and the liquid resin material poured over it. In such a case, the resin material is bonded to the fabric such that the two elements may not be easily separated.

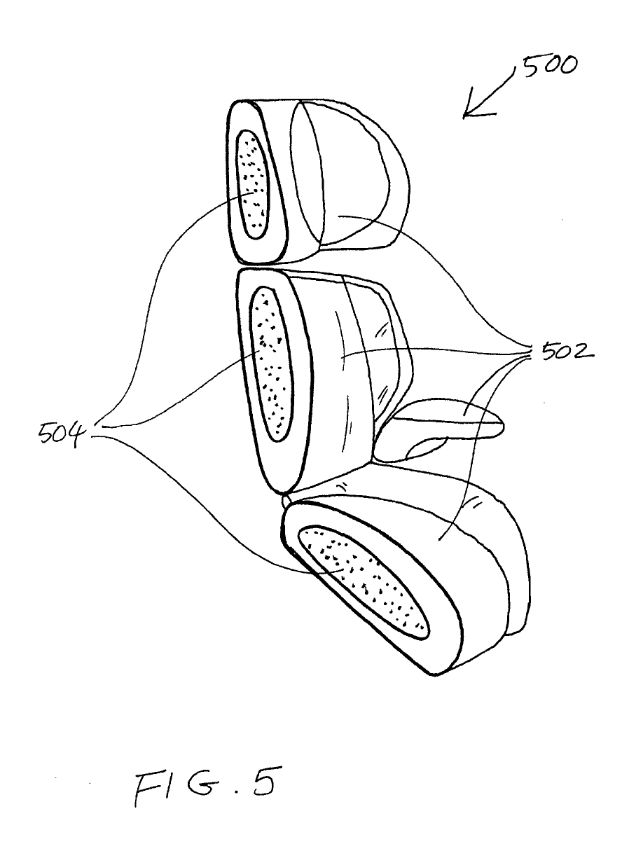

As mentioned, the material used for the seating surface of the seat is a varying density closed cell foam polymer resin material. Referring now to FIG. 5, this material encloses a core of another material. More specifically a seating surface 502 (constructed of a varying density closed cell foam polymer resin material) encloses a core material 504. The core material 504 may be any suitable material such as styrofoam. Other examples of core materials are possible. In one example, the core material includes no more than 50 percent of the overall volume of the seating surface, with no less than 10 millimeters thickness of foam resin material surrounding the core in any area.

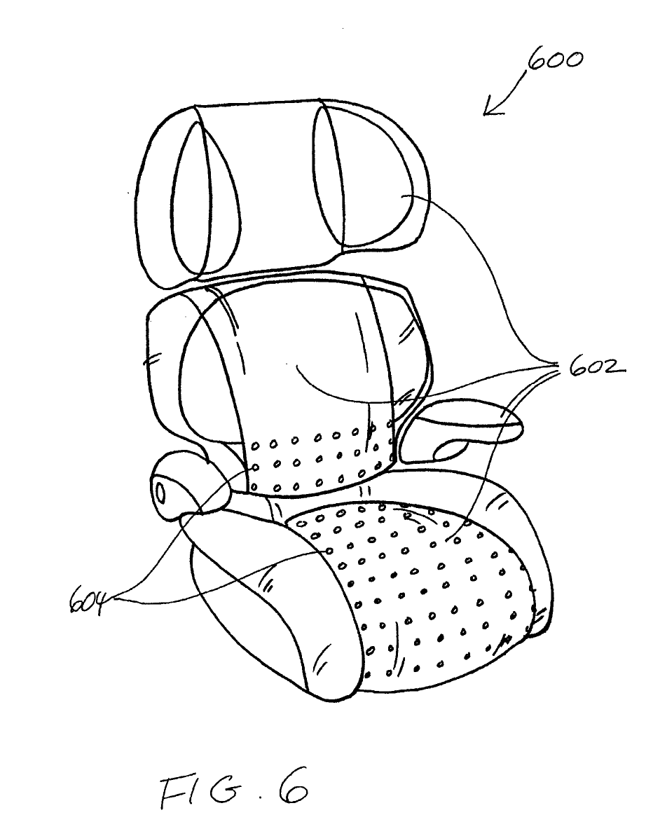

Referring now to FIG. 6, bumps or surface textures (e.g., reverse bumps or depressions) may be incorporated into the seating surface. Specifically, a seating surface 602 of a seat 600 includes bumps 604. The bumps 604 are also constructed of the varying density closed cell foam polymer resin material. In one configuration, they are arranged in a square grid pattern or arrangement. In one example, the bumps may be hemispherical in shape, with a height of 2.5 millimeters above the underlying surface. Other examples of shapes and dimensions are possible.

The bumps 604 provide a massage effect to the passenger, similar to therapeutic sandals for walking, especially during long drives. These surface textures also create air channels or air gaps between the seating surface and the skin touching it, for better ventilation and comfort.

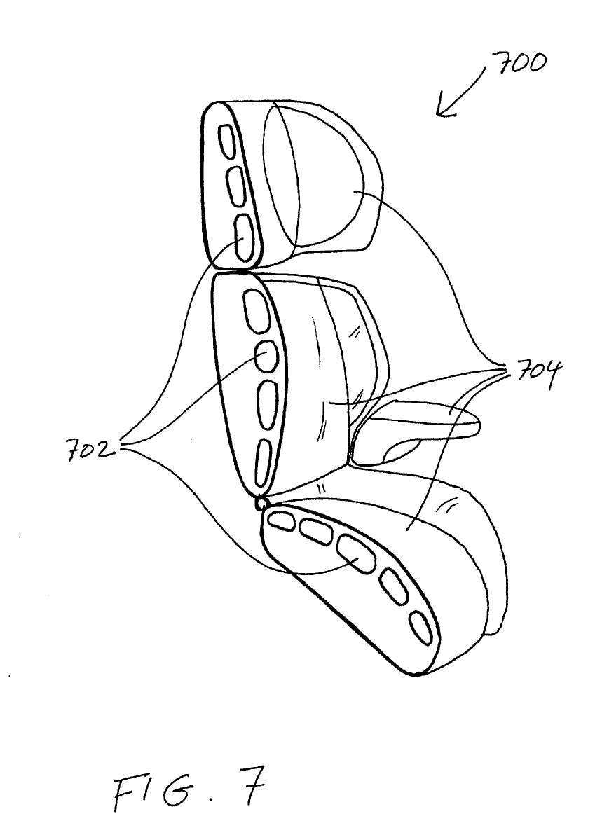

In yet another example and now referring to FIG. 7, air chambers 702 may be formed within a seat surface 704 of a seat 700. These chambers 702 are sufficiently larger than the pores formed within the rest of the material. In one example, the air chambers may be hollow or filled with a gaseous material. In one configuration, the chambers are formed so that the entire volume is 50 percent of the total volume of the seating surface material. In one example, the chambers are elliptical in cross-section. In another configuration, the cross-section of the chambers is directly determined by using a preset offset distance from the outermost seating surface. Other shapes and configurations for the chambers are possible.

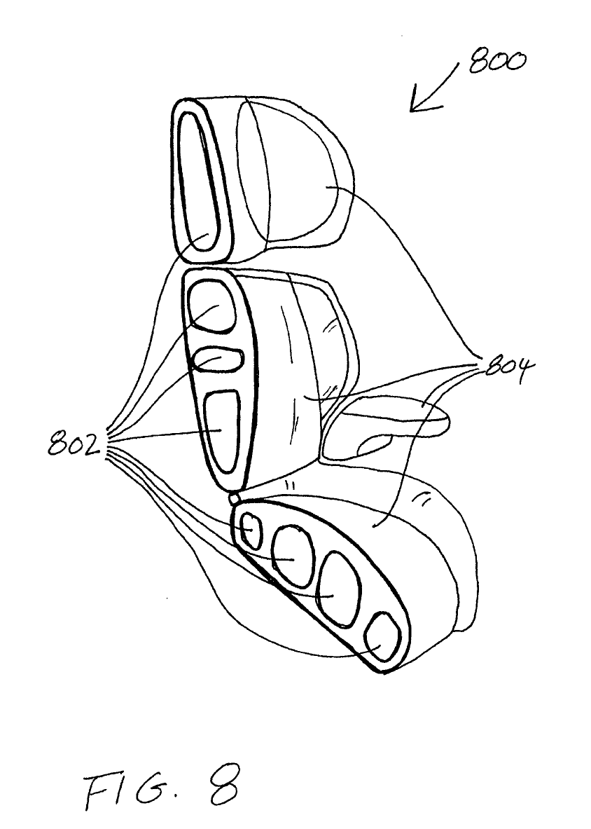

In another example, and now referring to FIG. 8, hollow chambers 802 may be formed within the seating surface 804 of a seat 800. These chambers 802 are sufficiently larger than the pores formed within the rest of the material in the seating surface 804. The air chambers 802 may be filled with air or a gaseous material. The closed cell nature of the material traps the enclosed air within those spaces, forming a cushioning system based upon the closed air pockets within the seating surface. In this case, open cell material which has interconnected pores cannot contain enclosed air to form closed pockets.

In yet another example, the hollow chambers may be filled with a light weight solid, semisolid or liquid filler material. Other materials may also be used.

The closed cell foam polymer resin based materials are moisture repellant. In the event of a liquid spill in the seat, the liquid is not absorbed into the seat but pools on the surface so it may be quickly and easily cleaned up. This prevents the creation of a wet and unpleasant environment for the child or other occupant to be seated in. Consequently, the approaches described herein do not require that moisture repellant finishes be applied to it to make it repel liquids. Any such finishes, used elsewhere in conjunction with alternate seating surfaces such as fabrics, would likely wear out over time and through frequent use. The ease of cleanup also makes it more likely that the seat will be cleaned more often, creating a more hygienic and potentially safer environment for the child or other occupant than may be possible with most traditionally used surface cover materials such as fabric. Fabric covers, once saturated in the event of a spill, usually must be removed from the seat to be thoroughly cleaned, which is a more time consuming and laborious process.

The closed cell foam polymer resin based materials used herein also provide thermal insulation without the use of additional materials or layers. This feature is advantageous in colder weather to provide warmth for the child passenger (or other occupant).

The use of these closed cell foam polymer resin based materials may also produce a fine surface finish without the application of a secondary material, such a fabric, leather, and so forth. As part of the forming process, textures and other finishes may be formed into the outermost layer of the material. The outermost layer may be such that its density is significantly higher than the material below. A higher density could provide a naturally high-finish surface.

The closed cell foam polymer resin based materials used herein are also naturally soft and pliable, which provides comfort for the seated child or other occupant without the need for additional padding materials. This provides for a simplified manufacturing process that utilizes fewer elements to achieve the same results as a regular fabric based seat.

In one example, the composition of the material may be such that it is rendered softer through body heat, wherever the body of the occupant comes in contact with it. This creates a more comfortable seated experience for the occupant, without the need for any additional padding or other comfort elements.

Furthermore, the closed cell foam polymer resin based materials used herein have excellent non-slip properties. In the event of a sudden movement such as a collision, this would provide a gripable surface for the body of the seat occupant to hold onto or be held onto. In one embodiment, the inherent non-slip properties may be supplemented with a pattern of raised dots or lines to create a single surface with further enhanced non-slip functionality.

The foamed nature of the polymer resin is significantly lighter than unfoamed materials. As a result, the weight of the seat may be reduced. This makes the seat easier to move from one location to another and also allows for easier adjustability. A significant number of accidents related to child seats occur due to improper placement and adjustment of the seat. Lighter weight makes correct placement and adjustment easier to perform, reducing the incidence of such accidents.

The lower costs of the simplified manufacturing and assembly process allows for the possibility of creating and using customized shapes and sizes for the seating surfaces more readily, with the same beneficial qualities described above. In the case of an individual with a specific requirement, such as a disability or deformity, a customized seating surface may offer far greater comfort than simply a modified existing seating surface.

In the case of individuals who remain seated for long periods of time, the flow of blood to some parts of the body may become compromised. As a result, certain body parts and/or body functions may become less functional or damaged. For example, pressure sores are an innate risk for people seated for long periods of time, such as wheelchair users. With simplified manufacturing and assembly, and the resultant ease of customization, customizable seating surfaces are provided that allow for good seat ergonomics using the approaches described herein.

Also, many previous seating systems offer little in the way of lumbar support. Using the approaches described herein, improved lumbar support is provided.

The lighter nature of the foam also facilitates the creation and use of the customized seating surfaces, even bulkier ones, without a significant increase in weight, leading to wider acceptance. As a result, more people who need these custom seats will actually use them.

The above-mentioned properties of closed cell foam polymer resin based materials allow for the use of a single material with numerous beneficial properties where typically numerous materials would be necessary. This allows for a reduction in weight and complexity, manufacturing issues and environmental impact. A larger number of components increase the possibility of failure and unsatisfactory performance, damage to the seat and the occupant. Typically, a reduction in these areas also translates to a reduction in the cost of production, which could mean greater affordability for larger groups of people.

While the invention herein disclosed has been described by means of specific embodiments and applications thereof, numerous modifications and variations could be made thereto by those skilled in the art without departing from the scope of the invention.

What is claimed is:

1. A seat comprising:
a base portion;
a seat portion arranged to communicate with the base portion; and
wherein the seat portion is formed at least in part from a varying density closed cell foam polymer resin material.

2. The seat of claim 1 wherein the seat is dimensioned so as to be usable by a child.

3. The seat of claim 1 wherein the seat portion includes an underlying structure and the closed cell foam polymer resin material is permanently attached to the underlying structure.

4. The seat of claim 1 wherein the seat portion includes an underlying structure and the closed cell foam polymer resin material is removably attached to the underlying structure.

5. The seat of claim 1 further comprising at least one hollow chamber formed within the closed cell foam polymer resin material.

6. The seat of claim 1 further comprising at least one surface texture formed on a surface of the seat portion.

7. The seat of claim 1 wherein the surface texture comprises a texture selected from a group consisting of a bump and a depression.

8. The seat of claim 1 wherein the varying density closed cell foam polymer resin material is mixed with an additive.

9. The seat of claim 8 wherein the additive is selected from a group consisting of natural cork, rubber, sawdust and a non reactive filler material.
